(19) United States
(12) Patent Application Publication
(10) Pub. No.: US 2014/0236908 A1
(43) Pub. Date: Aug. 21, 2014

(54) METHOD AND APPARATUS FOR PROVIDING ENHANCED DATA RETRIEVAL WITH IMPROVED RESPONSE TIME

(71) Applicant: VERIZON PATENT AND LICENSING INC., Basking Ridge, NJ (US)

(72) Inventors: Ramanujam Achan SETHURAMAN, Irving, TX (US); Ramesh Babu RAMAKRISHNAN, Flowermound, TX (US); Sundaresan RAMASUBRAMANIAN, Irving, TX (US); Felix R. TORRES-SANTIAGO, Irving, TX (US); Sanjay BASU, Plano, TX (US); Velamur Srinivasan Sudharsan, Flowermound, TX (US); Vivek Gurumurthy, Irving, TX (US); Ravi Kalavagunta, Irving, TX (US)

(73) Assignee: VERIZON PATENT AND LICENSING INC., Basking Ridge, NJ (US)

(21) Appl. No.: 13/772,030

(22) Filed: Feb. 20, 2013

(51) Int. Cl. G06F 17/30

(52) U.S. Cl. CPC G06F 17/30371
USPC 707/693

(57) ABSTRACT

An approach for providing enhanced data retrieval with improved response time is described. An enhanced data retrieval platform may retrieve data associated with multiple accounts from multiple database records within multiple databases, wherein each database record of the multiple database records is associated with a different type of information. The enhanced data retrieval platform may further create a single database entry for each account of the multiple accounts based on the retrieved data. The enhanced data retrieval platform may also compress the single database entry. Additionally, the enhanced data retrieval platform may store the compressed single database entry in a cache.

### BACKGROUND INFORMATION

Where a large service-oriented architecture system handles heavy load of data for enterprises, accessibility and response time of the data is critical to the enterprises. Improvement in response time can result in increased productivity of end users, which, as a whole, in turn could result in cost savings to the enterprise. For example, where 100 calls are handled by a customer representative in a day with an average call time of 3 minutes and data retrieval time of 30 seconds, if the data retrieval time can be reduced from 30 seconds to 15 seconds, this could result in an additional 1500 seconds and would allow the customer representative to handle 10 more calls a day (which is equivalent to a 10% cost reduction). Further, more often than not systems are distributed over the network and customer information in a huge enterprise could be stored in more than one system (which requires multiple calls to get the data). For example, if a customer orders a pay-per-view channel from a set-top box, the system might have to go through different systems to retrieve the customer's data, check the customer's credit, check promotions for the customer, etc. Since the response time to the customer should not be more than few seconds, the response time becomes more critical.

Therefore, there is a need for minimizing the response time to customer inquiries in large service-oriented architectures.

### BRIEF DESCRIPTION OF THE DRAWINGS

Various exemplary embodiments are illustrated by way of example, and not by way of limitation, in the figures of the accompanying drawings in which like reference numerals refer to similar elements and in which:

FIGS. 1A and 1B are diagrams of a system capable of providing enhanced data retrieval with improved response time, according to various exemplary embodiments;

FIG. 2 is a diagram of an enhanced data retrieval platform utilized in the system of FIG. 1, according to an exemplary embodiment;

FIG. 3A is a flowchart of an offline processing for providing enhanced data retrieval with improved response time, according to an exemplary embodiment;

FIG. 3B is a flowchart executing enhanced data retrieval with improved response time in response to a customer inquiry, according to an exemplary embodiment;

FIG. 4 is a diagram of a computer system that can be used to implement various exemplary embodiments; and

FIG. 5 is a diagram of a chip set that can be used to implement various exemplary embodiments.

### DESCRIPTION OF THE PREFERRED EMBODIMENT

A method, apparatus, and system for providing enhanced data retrieval with improved response time, is described. In the following description, for the purposes of explanation, numerous specific details are set forth in order to provide a thorough understanding of the present invention. It is apparent, however, to one skilled in the art that the present invention may be practiced without these specific details or with an equivalent arrangement. In other instances, well-known structures and devices are shown in block diagram form in order to avoid unnecessarily obscuring the present invention.

Although the various exemplary embodiments are described with respect to providing enhanced data retrieval as part of a call center operation, it is contemplated that these embodiments have applicability to other systems operated by different entities and to other operations wherein data is retrieved.

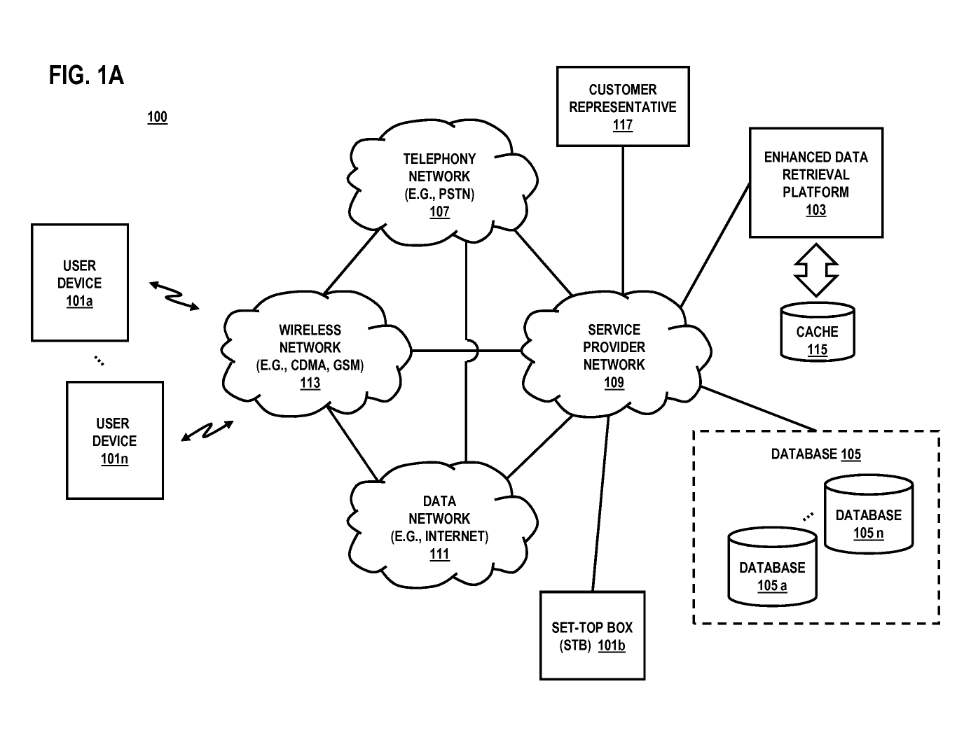

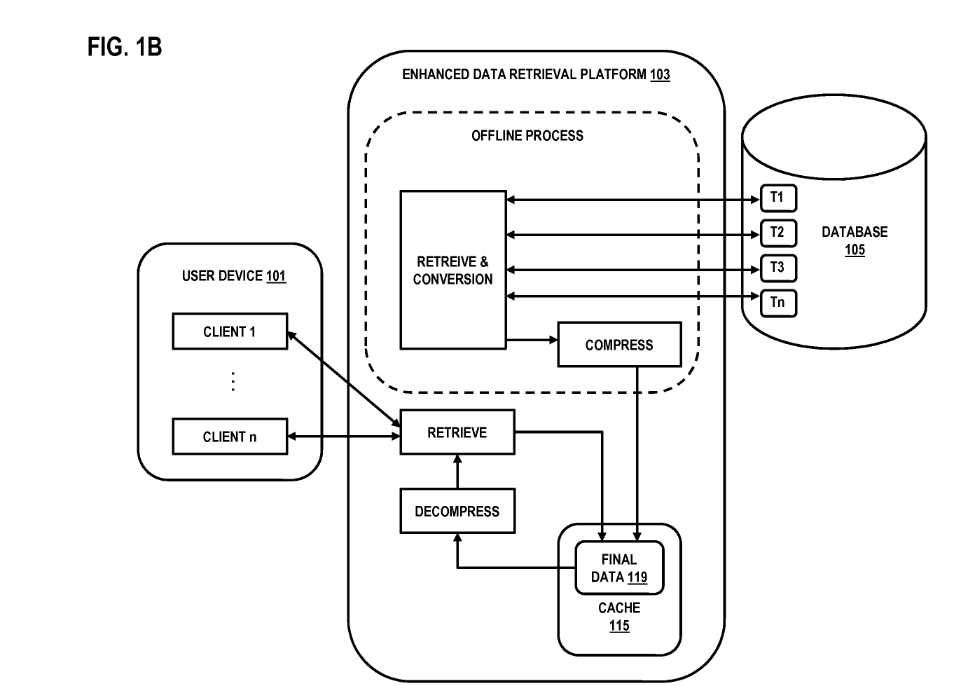

FIG. 1A is a diagram of a system capable of providing enhanced data retrieval with improved response time, according to an exemplary embodiment. For the purposes of explanation, system 100 is described in the context of an enterprise infrastructure. As noted, where a large service-oriented architecture (SOA) system handles heavy load of data for enterprises, accessibility and response time of the data is critical to the enterprises. A typical enterprise application retrieves more data than it has. Data retrieval normally constitutes more than 75% of the entire data traffic. Large SOA applications normally provide different web services for different functionality and most of them have different types of clients. For example, a user can request data through the Internet, which in turn calls a web service to retrieve the requested data. Also, the user can request information through a customer representative at a customer call center. If the user calls the customer call center for information, the customer representative can retrieve the requested information from the web service through the customer representative's computer. In addition, there are other means (e.g., an automated phone, a set-top box, etc.) where the user can interact with the system without any intermediary person or system.

The approach of system 100 stems, in part, from the recognition that minimizing the response time associated with data retrieval could have a marked benefit in productivity of the system and cost reduction. As shown, the system 100 includes an enhanced data retrieval platform 103 implemented as, for example, part of a service provider network 109 for retrieving data from a cache 115 in response to requests from user devices 101a-101n (collectively user device 101), where the data is initially retrieved from databases 105a-105n (collectively, database 105). However, in alternative embodiments, the enhanced data retrieval platform 103, the database 105, and the user device 101 may be implemented as any part of the system 100. For example, the user device 101 may be implemented as part of the telephony network 107, the service provider network 109, or the data network 111. The database 105 may also be implemented as part of the telephony network 107, the service provider network 109, or the data network 111. The service provider network 109 can interact with one or more other networks, such as the telephony network 107, the data network 111, and/or the wireless network 113. Also, it is noted that the customer representative 117 may be implemented as part of the service provider network 109.

In certain embodiments, the user device 101 may include any type of computing device comprising a mobile handset, mobile phone, mobile station, desktop computer, tablet computer, laptop computer, netbook computer, personal digital assistants (PDAs), smartphone, communication receiver, media receiver, set-top box, etc.

Further, other user devices may include a set-top box 101b that connects to the service provider network 109. Set-top box 101b includes, for example, a device that connects to a television, media player, etc., and an external source of signal (e.g., media service provider (not shown)), turning the signal into content which is then displayed on the television screen or other display device. Set-top boxes process signals for presenting audio-visual content (e.g., broadcast television programs, Video On Demand (VOD) programs, pay-per-view programs, Internet Protocol television (IPTV) feeds, DVD related content, etc.), pre-recorded media content, data communication services content (e.g., commercials, advertisements, videos, movies, songs, images, sounds, etc.), Internet services content (streamed audio, video, or image media), and/or any other equivalent media form.

It is also contemplated that the user device 101 may support any type of interface for supporting the presentment or exchange of data. In addition, the user device 101 may facilitate various input means for receiving and generating information, including touch screen capability, keyboard and keypad data entry, voice-based input mechanisms, and the like. Any known and future implementations of user device 101 are applicable. It is noted that, in certain embodiments, the user device 101 may be configured to transmit information (e.g., audio signals, words, address, etc.) using a variety of technologies—e.g., near field communication, RFID, WiFi, Bluetooth®, infrared, etc. Also, connectivity may be provided via a wired or wireless local area network (LAN). The user device 101 may request information directly to the enhanced data retrieval platform 103, or indirectly through a customer representative 117.

In certain embodiments, the enhanced data retrieval platform 103 may retrieve data stored in multiple databases (e.g., databases 105) and convert the data into a single data entry. The single data entry may be compressed and stored in the cache 115, which may be embedded in the enhanced data retrieval platform 103 or elsewhere. The retrieving, converting, and storing may be performed in an offline process. Further, the enhanced data retrieval platform 103 may receive a request for information directly from the user device 101 or indirectly through a customer representative 117. The enhanced data retrieval platform 103 may then fetch the requested information from the cache based on the request. The fetched data, which may be in a compressed format, may be decompressed back to a requested format. The decompressed data then may be parsed to identify the requested information. The identified information then may be sent to the user device 101. Further details about the operation of the enhanced data retrieval platform 103 are described below.

In certain embodiments, the database 105 may be a structured collection of data. The database 105 may be associated with database management systems (DBMS) (e.g., Oracle, FoxPro, IBM DB2, Linter, Microsoft Access, Microsoft SQL Server, MySQL, PostgreSQL, SQLite, etc.). The database 105 may include various databases of different types comprising an active database, cloud database, distributed database, documented-oriented database, end-user database, operational database, parallel database, graph database, knowledge base, unstructured-data database, etc. Further, the database 105 may include various databases of different contents comprising a profile database, a service database, a promotion database, a purchase record database, a contents database, etc. The profile database may contain information regarding users or customers, such as names, addresses, phone numbers, dates of birth, social security numbers, current receiving services, purchase histories, etc. The service database may contain information regarding services provided by the service provider, such as service names, prices, descriptions of service, availabilities to certain users or different regions, etc. The promotion database may contain information regarding promotions, deals, coupons, advertisements, availabilities to certain users or regions, etc. The contents database may contain multimedia contents (e.g., video, audio, images, etc.), documents, software, etc. For example, the database 105 may be accessed to retrieve different types of information (e.g., profile information, service information, promotion information) associated with each user account. The various types of information may be stored in different relational database tables in one or more of the databases 105.

For illustrative purposes, the networks 107-113 may be any suitable wireline and/or wireless network, and be managed by one or more service providers. For example, telephony network 107 may include a circuit-switched network, such as the public switched telephone network (PSTN), an integrated services digital network (ISDN), a private branch exchange (PBX), or other like network. Wireless network 113 may employ various technologies including, for example, code division multiple access (CDMA), enhanced data rates for global evolution (EDGE), general packet radio service (GPRS), mobile ad hoc network (MANET), global system for mobile communications (GSM), Internet protocol multimedia subsystem (IMS), universal mobile telecommunications system (UMTS), etc., as well as any other suitable wireless medium, e.g., microwave access (WiMAX), wireless fidelity (WiFi), satellite, and the like. Meanwhile, data network 111 may be any local area network (LAN), metropolitan area network (MAN), wide area network (WAN), the Internet, or any other suitable packet-switched network, such as a commercially owned, proprietary packet-switched network, such as a proprietary cable or fiber-optic network.

Although depicted as separate entities, the networks 107-113 may be completely or partially contained within one another, or may embody one or more of the aforementioned infrastructures. For instance, the service provider network 109 may embody circuit-switched and/or packet-switched networks that include facilities to provide for transport of circuit-switched and/or packet-based communications. It is further contemplated that networks 107-113 may include components and facilities to provide for signaling and/or bearer communications between the various components or facilities of system 100. In this manner, the networks 107-113 may embody or include portions of a signaling system 7 (SS7) network, or other suitable infrastructure to support control and signaling functions.

In certain embodiments, the cache 115 may be a component that transparently stores data so that future requests for the data can be served faster. The data stored within the cache 115 may be values that have been computed earlier or duplicates of original values that are stored elsewhere. If requested data is contained in the cache 115, the request can be served by simply reading the cache 115, which is comparatively faster than re-computing and/or retrieving the data from its original storage location, which may require multiple calls for the data. The cache 115 may be a part of the enhanced data retrieval platform 103 or may be a separate component within the system 100. The data retrieved from the database 105, which may be converted and compressed, may be stored in the cache 115 with an identifier or metadata indicating a corresponding user account. Further, the cache 115 may be scalable, so that the cache 115 can be enlarged as the size of data in the cache 115 increases. In that way, a greater number of future requests can be served from the cache 115, which leads to the faster overall system performance.

In certain embodiments, the customer representative 117 may include any type of computing device comprising a mobile computer, desktop computer, tablet computer, laptop computer, netbook computer, communication receiver, media receiver, etc. The customer representative 117 may receive a request for information from the user device 101. In respond to the request, the customer representative 117 may send another request for the information to the enhanced data retrieval platform 103. Then, the customer representative 117 may receive the requested information identified by the enhanced data retrieval platform 103 and send the received information back to the user device 101. In certain embodiment, the customer representative 117 may be embedded with the enhanced data retrieval platform 103.

FIG. 1B is a diagram of a system capable of providing enhanced data retrieval with improved response time, according to another exemplary embodiment (specific to an operation of the enhanced data retrieval platform 103). In certain embodiments, the enhanced data retrieval platform 103 may retrieve data stored in multiple database tables T1-Tn associated with the database 105. The retrieving process may take multiple calls (e.g., N calls) to the database 105. Further, the retrieved data may be converted to a single relational entry (e.g., XML file).

As used herein, the term “XML” refers to Extensible Markup Language. XML may be a markup language that defines a set of rules for encoding a document in a format that is both human-readable and machine-readable. XML may be a textual data format with strong support via Unicode for the language of the world. For example, an XML document may be a string of characters. An XML processor may analyze the markup and pass structured information to an application. An XML specification may place requirements on what an XML must do and not do. The XML processor may be referred to colloquially as an XML parser.

The retrieving process and the converting process may be performed in an offline process so that, for example, the fetching process and the converting process may have no impact to front end clients Client 1-Client n, which may represent user device 101. Furthermore, the single relational entry may be compressed to final data 119. In that way, the compressing process may save storage space in the cache 115 or database 105. The compressed data may be stored in a binary format. Also, the compressing process may be performed in an offline process. Additionally, the final data 119 may be stored in a fast-access memory or the cache 115 for a faster access in the future. The cache 115 may be embedded in the enhanced data retrieval platform 103 or may be separate from the enhanced data retrieval platform 103.

In certain embodiments, the enhanced data retrieval platform 103 may receive requests for information associated with the final data 119 from the Client 1-Client n. The enhanced data retrieval platform 103 may retrieve the final data 119 from the cache 115 through a single fetch without making multiple calls to the database 105 to fetch the requested information from the multiple tables T1-Tn. The retrieved final data 119 may be decompressed back to the single relational entry (e.g., XML file). The single relational entry may be parsed and searched for the requested information and the identified information may be sent to the Client 1-Client n. In that way, improvement in the response time to the information request can be achieved.

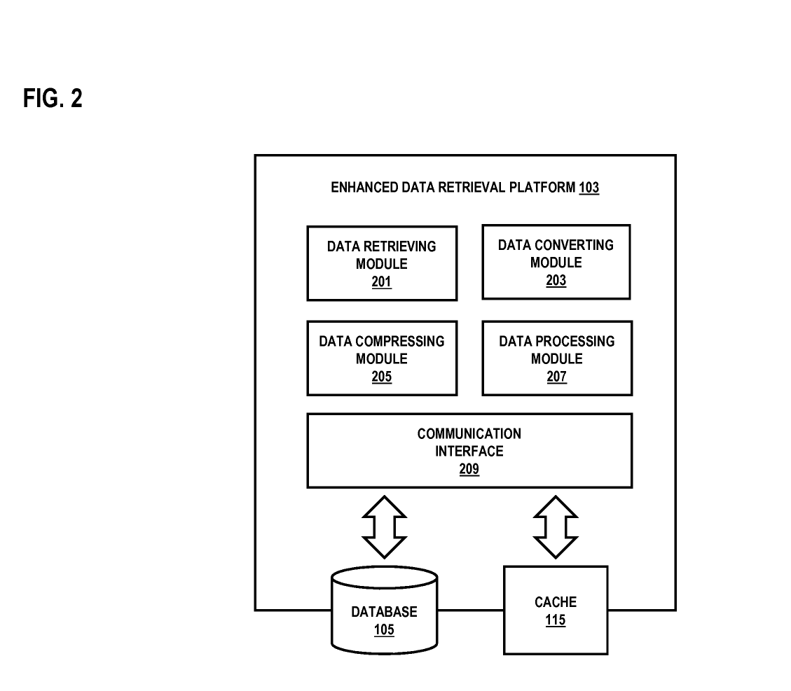

FIG. 2 is a diagram of an enhanced data retrieval platform utilized in the system of FIG. 1, according to an exemplary embodiment. The enhanced data retrieval platform 103 may include a data retrieving module 201, a data converting module 203, a data compressing module 205, a data processing module 207, and a communication interface 209. In certain embodiments, the enhanced data retrieval platform 103 may also include the cache 115. Further, the enhanced data retrieval platform 103 may be in communication with the database 105.

In one embodiment, the data retrieving module 201 may be configured to retrieve data associated with multiple accounts from multiple database records. The multiple database records may be stored in multiple databases (e.g., database 105). The multiple accounts may include user/customer accounts. In certain embodiments, each database record of the multiple database records may be associated with a different type of information. Each database record may be related to information comprising user/customer profiles, services, promotions, contents, financial transactions, etc. For example, the data retrieving module 201 may retrieve each user's profile data associated with each user's account from multiple database records (e.g., all-user account data records), where the each user's profile data may be a part of the all-user account data records and stored in multiple database tables (e.g., database 105).

In one embodiment, the data retrieving module 201 may be further configured to retrieve a compressed single database entry associated with one account from the cache 115 based on a request. The compressed single database entry may be searched based on an identifier within the request indicating the one account. The cache 115 may contain a data structure table that maps the identifier to the compressed single data entry. For example, an identifier “x001” that corresponds to a user account may be contained in the request and the identifier may be used as a key to retrieve the compressed data of the user account from the cache 115. In certain embodiments, the retrieving may be performed through a single retrieval. The single retrieval may include one call, one hop, one trip, or one access to the cache 115.

In one embodiment, the data converting module 203 may be configured to convert the retrieved data from the data retrieving module 201 to a single database entry for each account of the multiple accounts. The single database entry may include a single relational database table. Further, the single database entry may be in an Extensible Markup Language (XML) format. For example, the data converting module 203 may convert the retrieved profile data or any other data associated with each user account to a single relational database table or an XML file for each user account. The single relational database table or the XML file may contain any and all data (e.g. user profiles, services, promotions, contents, financial transactions, etc.) associated with each user account and retrieved by the data retrieving module 201. One relational database table or the XML file may be created for each user account.

In one embodiment, the data compressing module 205 may be configured to compress the single database entry. The compression may involve encoding data using fewer bits than the original representation. The compression can be either lossy or lossless compression. No information is lost in lossless compression and lossy compression reduces bits by identifying marginally important information and removing it. For example, a 500 kB single relational database table or a XML file converted by the data converting module 203 may be compressed to 3 kB of data. The compressed data may be in a binary format. In that way, the compression may help reducing the resource usage, such as data storage space or transmission capacity.

In one embodiment, the data compressing module 205 may be further configured to decompress the compressed single database entry from the binary format into the XML format in response to a request. The decompression is a reverse process of the compression to yield the original data. The compressed single database entry, retrieved by the data retrieving module 201, which may be in the binary format, may be decompressed back to the XML format or another format that the request indicates. For example, the user's compressed account data retrieved by the data retrieving module 201 may be decompressed to back to the single database entry or the XML file.

In one embodiment, the data processing module 207 may be configured to parse the decompressed single database entry based on a type of information, a contextual criterion, or a combination thereof associated with the one account. The type of information may include user profile information, services information, contents information, transaction information, purchase information, promotion information, etc. The contextual criterion may include dates, ages, privacy levels, prices, etc. The parsing data may include analyzing the data by parts. For example, the single database entry decompressed by the data compression module 205 may contain different types of information associated with the one user account. The request may contain a query or metadata specifying a type of information requested and/or a contextual criterion for filtering the requested information. By way of example, the user may request the user's pay-per-view order history for the last month. The user's purchase information may be parsed from the single database entry or the XML file containing the user's whole account information. The parsed user's purchase information may be further parsed to the user's pay-per-view order history for the last month.

Further, the data processing module 207 may be configured to identify the requested information from the decompressed single database entry based on the parsed single database entry and the request. The requested information may be searched from the parsed single database entry based on one or more search criterions (e.g., keywords, names of entry, etc.) contained in the request. The information matching the keyword or the entry may be identified from the parsed single database entry. For example, the user's pay-per-view order history of last month (the parsed user's account information) parsed by the data processing module 207 may be further searched for a name of a movie or a price of an order specified in the user request.

In one embodiment, the communication interface 209 may be configured to communicate with other components of the enhanced data retrieval platform 103 (e.g., the data retrieving module 201, the data converting module 203, the data compressing module 205, the data processing module 207, the database 105, the cache 115, etc.) and other components of the system 100, including the user device 101 and the database 105. The communication interface 209 may include multiple means of communication. For example, the communication interface 209 may be able to communicate via wired or wireless links, over short message service (SMS), multimedia messaging service (MMS), Internet protocol (IP), instant messaging, voice sessions (e.g., via a phone network), email, NFC, QR code, or other types of communication.

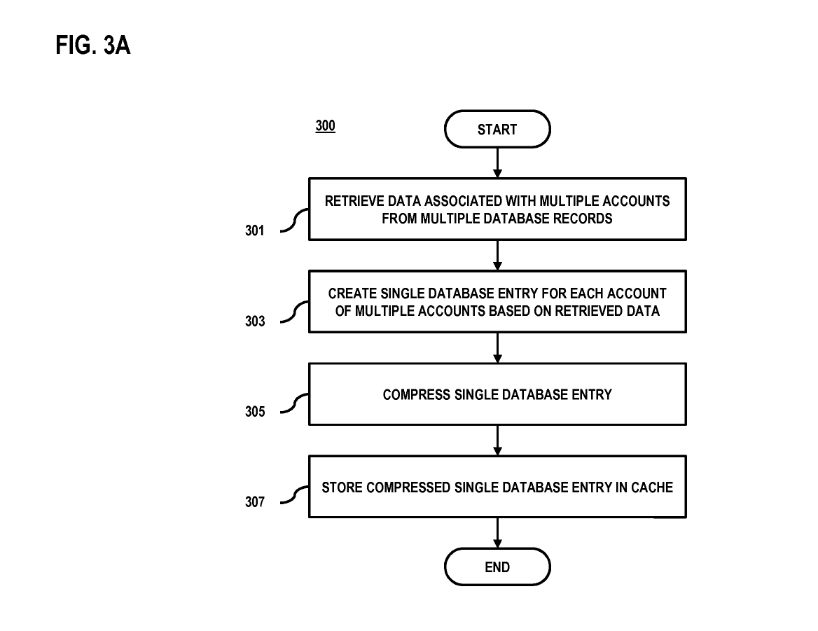

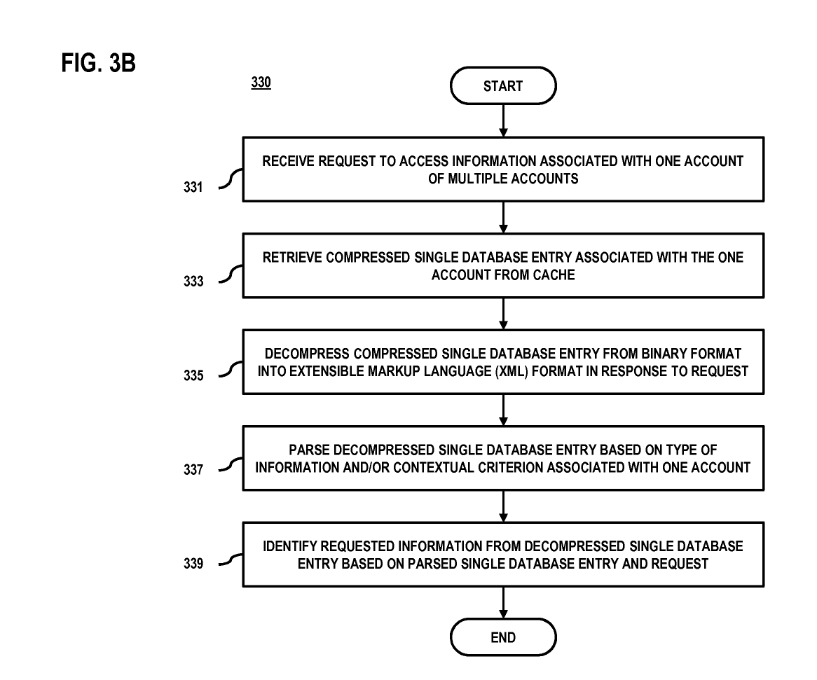

FIGS. 3A and 3B are flowcharts processing associated with providing enhanced data retrieval with improved response time, according to various exemplary embodiments. For illustrative purposes, the processes 300 and 330 are described with reference to FIGS. 1A and 1B. The steps of the processes 300 and 330 may be performed in any suitable order, as well as combined or separated in any suitable manner. In particular, FIG. 3A is illustrated to describe the process 300 of preparing for a data retrieval request from the perspective of the enhanced data retrieval platform 103.

At step 301, the enhanced data retrieval platform 103 may retrieve data associated with multiple accounts from various database records. The database records may be stored in multiple disparate databases (e.g., database 105). The accounts may include user/customer accounts. In certain embodiments, each database record of the multiple database records may be associated with a different type of information. Each database record may be related to information comprising user/customer profiles, services, promotions, contents, financial transactions, etc. For example, the enhanced data retrieval platform 103 may retrieve each user's profile data associated with each user's account from multiple database records (e.g., all-user account data records), where each user's profile data may be a part of the all-user account data records and stored in multiple database tables (e.g., database 105).

At step 303, the enhanced data retrieval platform 103 may create a single database entry for each account of the multiple accounts based on the retrieved data. The single database entry may include a single relational database table. Further, the single database entry may be in an Extensible Markup Language (XML) format. For example, the enhanced data retrieval platform 103 may create a single relational database table or an XML file for each user account based on the retrieved profile data or any other data associated with each user account. The single relational database table or the XML file may contain any data (e.g. user profiles, services, promotions, contents, financial transactions, etc.) associated with each user account and retrieved at step 301. One relational database table or the XML file may be created for each user account.

At step 305, the enhanced data retrieval platform 103 may compress the single database entry. The compression may involve encoding data using fewer bits than the original representation. The compression can be either lossy or lossless compression, depending on the application. That is, no information is lost in lossless compression, and lossy compression reduces bits by identifying marginally important information and removing it. For example, a 500 kB single relational database table or a XML file created at step 303 may be compressed to 3 kB of data. The compressed data may be in a binary format. In that way, the compression may reduce the resource usage, such as data storage space or transmission capacity.

At step 307, the enhanced data retrieval platform 103 may store the compressed single database entry in the cache 115. The cache 115 may be a component that transparently stores data so that future requests for the data can be served faster. The data stored within the cache 115 may be a value that has been computed earlier or duplicates of original values that are stored elsewhere. If requested data is contained in the cache 115, the request can be served by simply reading the cache 115, which is comparatively faster than re-computing or fetching the data from its original storage location, which may include multiple locations and require multiple calls. The cache 115 may be embedded in the enhanced data retrieval platform 103 or elsewhere. The compressed single data entry may be stored in the cache 115 with an identifier or metadata indicating corresponding user account. For example, the compressed data at step 305 may be stored in the cache 115 within the enhanced data retrieval platform 103 and an identifier indicating the user account may be assigned to the compressed data. In that way, a greater number of future requests can be served from the cache 115, thereby yielding faster overall system performance.

In certain embodiments, one or more of steps 301-307 may be performed through an offline process. The offline process may include processes performed in the background of the enhanced data retrieval platform 103 regardless of requests from the user device 101. For example, retrieving each user profile data from the database 105 (step 301), creating a single relational table or a XML file for each user based on the retrieved data (step 303), compressing the single relational tables or a XML files (step 305), and/or storing the compressed data in the cache 115 (step 307) may be performed regardless of requests from the user device 101. The offline process may be performed in advance to the request from the user device 101. In that way, the multiple calls to the database 105 may not be performed during retrieving of requested information, which leads to reduced response time for each information request.

FIG. 3B is illustrated to describe the process 330 of responding to the data retrieval request from the perspective of the enhanced data retrieval platform 103. Specifically, at step 331, the enhanced data retrieval platform 103 may receive a request to access information associated with one account of the multiple accounts. The request may be sent from the user device 101 from a customer and/or user associated with the service provider network. The request may include an identifier, a search query, metadata about requested information, etc. The one account of the multiple accounts may include a user account of multiple user account. For example, the enhanced data retrieval platform 103 may receive a request for a user's recent pay-per-view movie order history from the user's mobile device. The user's recent pay-per-view movie order history may be associated with the user's account out of all the user accounts.

At step 333, the enhanced data retrieval platform 103 may retrieve a compressed single database entry associated with the one account from the cache 115 based on the request. The compressed single database entry may be searched based on an identifier within the request indicating the one account. The cache 115 may contain a data structure table that maps the identifier to the compressed single data entry. For example, an identifier “x001” that corresponds to a user account may be contained in the request and the identifier may be used as a key to retrieve the compressed data of the user account from the cache 115. In certain embodiments, the retrieving may be performed through a single fetch. The single fetch may include one call, one hop, one trip, or one access to the cache 115.

At step 335, the enhanced data retrieval platform 103 may decompress the compressed single database entry from a binary format into an Extensible Markup Language (XML) format in response to the request. The decompression may be a reverse process of the compression at step 305. The compressed single database entry retrieved at step 333, which may be in the binary format, may be decompressed back to the XML format or another format the request indicates (e.g., an original format). For example, the user's compressed account data retrieved at step 333 may be decompressed to back to the single database entry or the XML file.

At step 337, the enhanced data retrieval platform 103 may parse the decompressed single database entry based on a type of information, a contextual criterion, or a combination thereof associated with the one account. The type of information may include user profile information, services information, contents information, transaction information, purchase information, promotion information, etc. The contextual criterion may include dates, ages, privacy level, price, etc. The parsing data process may analyze the data in segments. For example, the single database entry decompressed at step 335 may contain different types of information associated with the one user account. The request may contain a query or metadata specifying a type of information requested and/or a contextual criterion for filtering the requested information. By way of example, the user may request the user's pay-per-view order history for the last month. The user's purchase information may be parsed from the single database entry or the XML file containing the user's whole account information. The parsed user's purchase information may be further parsed to the user's pay-per-view order history for the last month.

At step 339, the enhanced data retrieval platform 103 may identify the requested information from the decompressed single database entry based on the parsed single database entry and the request. The requested information may be searched from the parsed single database entry based on a search criterion (e.g., keyword, name of entry, etc.) contained in the request. The information matching the keyword or the entry may be identified from the parsed single database entry. For example, the user's pay-per-view order history of last month (the parsed user's account information) at step 337 may be further searched for a name of movie or price of an order specified in the user request. Through the steps 331-339, the process 330 can retrieve the whole data associated with the request through a single fetch without making multiple calls to the database 105 and the requested information may identified from the whole data. In that way, the requested information can be sent to the user with improved response time.

The processes described herein for providing enhanced data retrieval may be implemented via software, hardware (e.g., general processor, Digital Signal Processing (DSP) chip, an Application Specific Integrated Circuit (ASIC), Field Programmable Gate Arrays (FPGAs), etc.), firmware or a combination thereof. Such exemplary hardware for performing the described functions is detailed below.

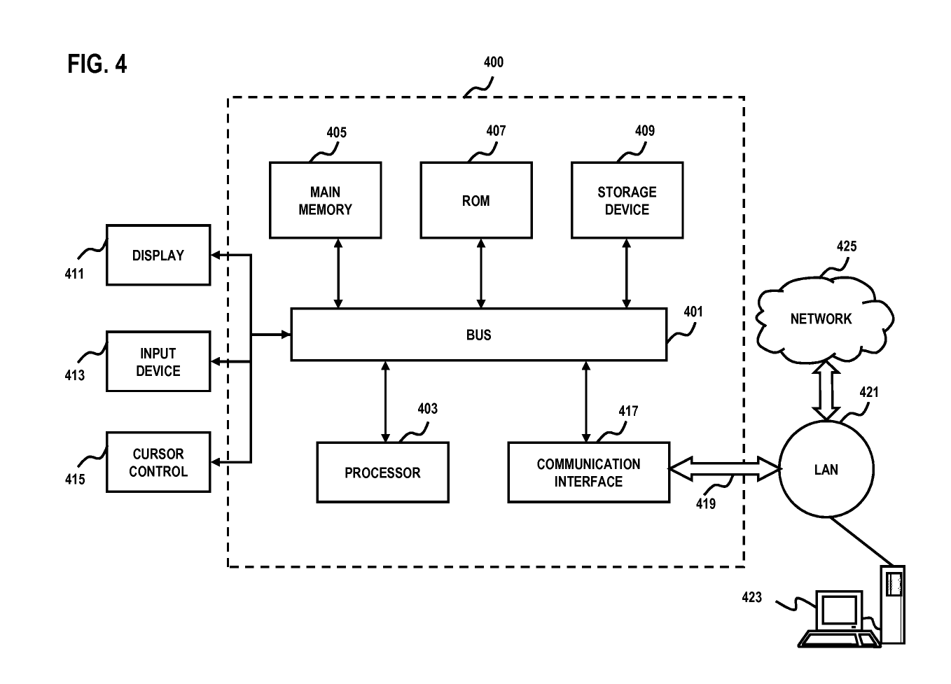

FIG. 4 illustrates computing hardware (e.g., computer system 400) upon which an embodiment according to the invention can be implemented. The computer system 400 includes a bus 401 or other communication mechanism for communicating information and a processor 403 coupled to the bus 401 for processing information. The computer system 400 also includes main memory 405, such as random access memory (RAM) or other dynamic storage device, coupled to the bus 401 for storing information and instructions to be executed by the processor 403. Main memory 405 also can be used for storing temporary variables or other intermediate information during execution of instructions by the processor 403. The computer system 400 may further include a read only memory (ROM) 407 or other static storage device coupled to the bus 401 for storing static information and instructions for the processor 403. A storage device 409, such as a magnetic disk or optical disk, is coupled to the bus 401 for persistently storing information and instructions.

The computer system 400 may be coupled via the bus 401 to a display 411, such as a cathode ray tube (CRT), liquid crystal display, active matrix display, or plasma display, for displaying information to a computer user. An input device 413, such as a keyboard including alphanumeric and other keys, is coupled to the bus 401 for communicating information and command selections to the processor 403. Another type of user input device is a cursor control 415, such as a mouse, a trackball, or cursor direction keys, for communicating direction information and command selections to the processor 403 and for controlling cursor movement on the display 411.

According to an embodiment of the invention, the processes described herein are performed by the computer system 400, in response to the processor 403 executing an arrangement of instructions contained in main memory 405. Such instructions can be read into main memory 405 from another computer-readable medium, such as the storage device 409. Execution of the arrangement of instructions contained in main memory 405 causes the processor 403 to perform the process steps described herein. One or more processors in a multi-processing arrangement may also be employed to execute the instructions contained in main memory 405. In alternative embodiments, hard-wired circuitry may be used in place of or in combination with software instructions to implement the embodiment of the invention. Thus, embodiments of the invention are not limited to any specific combination of hardware circuitry and software.

The computer system 400 also includes a communication interface 417 coupled to bus 401. The communication interface 417 provides a two-way data communication coupling to a network link 419 connected to a local network 421. For example, the communication interface 417 may be a digital subscriber line (DSL) card or modem, an integrated services digital network (ISDN) card, a cable modem, a telephone modem, or any other communication interface to provide a data communication connection to a corresponding type of communication line. As another example, communication interface 417 may be a local area network (LAN) card (e.g. for Ethernet™ or an Asynchronous Transfer Mode (ATM) network) to provide a data communication connection to a compatible LAN. Wireless links can also be implemented. In any such implementation, communication interface 417 sends and receives electrical, electromagnetic, or optical signals that carry digital data streams representing various types of information. Further, the communication interface 417 can include peripheral interface devices, such as a Universal Serial Bus (USB) interface, a PCMCIA (Personal Computer Memory Card International Association) interface, etc. Although a single communication interface 417 is depicted in FIG. 4, multiple communication interfaces can also be employed.

The network link 419 typically provides data communication through one or more networks to other data devices. For example, the network link 419 may provide a connection through local network 421 to a host computer 423, which has connectivity to a network 425 (e.g. a wide area network (WAN) or the global packet data communication network now commonly referred to as the “Internet”) or to data equipment operated by a service provider. The local network 421 and the network 425 both use electrical, electromagnetic, or optical signals to convey information and instructions. The signals through the various networks and the signals on the network link 419 and through the communication interface 417, which communicate digital data with the computer system 400, are exemplary forms of carrier waves bearing the information and instructions.

The computer system 400 can send messages and receive data, including program code, through the network(s), the network link 419, and the communication interface 417. In the Internet example, a server (not shown) might transmit requested code belonging to an application program for implementing an embodiment of the invention through the network 425, the local network 421 and the communication interface 417. The processor 403 may execute the transmitted code while being received and/or store the code in the storage device 409, or other non-volatile storage for later execution. In this manner, the computer system 400 may obtain application code in the form of a carrier wave.

The term “computer-readable medium” as used herein refers to any medium that participates in providing instructions to the processor 403 for execution. Such a medium may take many forms, including but not limited to non-volatile media, volatile media, and transmission media. Non-volatile media include, for example, optical or magnetic disks, such as the storage device 409. Volatile media include dynamic memory, such as main memory 405. Transmission media include coaxial cables, copper wire and fiber optics, including the wires that comprise the bus 401. Transmission media can also take the form of acoustic, optical, or electromagnetic waves, such as those generated during radio frequency (RF) and infrared (IR) data communications. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, and EPROM, a FLASH-EPROM, any other memory chip or cartridge, a carrier wave, or any other medium from which a computer can read.

Various forms of computer-readable media may be involved in providing instructions to a processor for execution. For example, the instructions for carrying out at least part of the embodiments of the invention may initially be borne on a magnetic disk of a remote computer. In such a scenario, the remote computer loads the instructions into main memory and sends the instructions over a telephone line using a modem. A modem of a local computer system receives the data on the telephone line and uses an infrared transmitter to convert the data to an infrared signal and transmit the infrared signal to a portable computing device, such as a personal digital assistant (PDA) or a laptop. An infrared detector on the portable computing device receives the information and instructions borne by the infrared signal and places the data on a bus. The bus conveys the data to main memory, from which a processor retrieves and executes the instructions. The instructions received by main memory can optionally be stored on storage device either before or after execution by processor.

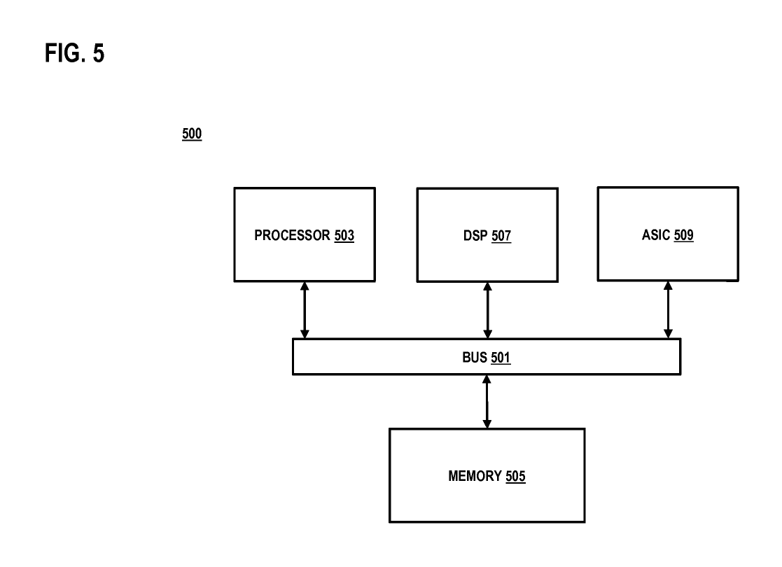

FIG. 5 illustrates a chip set 500 upon which an embodiment of the invention may be implemented. Chip set 500 is programmed to enhance data retrieval to improve response time and includes, for instance, the processor and memory components described with respect to FIG. 4 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set can be implemented in a single chip. Chip set 500, or a portion thereof, constitutes a means for performing one or more steps of FIGS. 3A and 3B.

In one embodiment, the chip set 500 includes a communication mechanism such as a bus 501 for passing information among the components of the chip set 500. A processor 503 has connectivity to the bus 501 to execute instructions and process information stored in, for example, a memory 505. The processor 503 may include one or more processing cores with each core configured to perform independently. A multi-core processor enables multiprocessing within a single physical package. Examples of a multi-core processor include two, four, eight, or greater numbers of processing cores. Alternatively or in addition, the processor 503 may include one or more microprocessors configured in tandem via the bus 501 to enable independent execution of instructions, pipelining, and multithreading. The processor 503 may also be accompanied with one or more specialized components to perform certain processing functions and tasks such as one or more digital signal processors (DSP) 507, or one or more application-specific integrated circuits (ASIC) 509. A DSP 507 typically is configured to process real-world signals (e.g., sound) in real time independently of the processor 503. Similarly, an ASIC 509 can be configured to performed specialized functions not easily performed by a general purposed processor. Other specialized components to aid in performing the inventive functions described herein include one or more field programmable gate arrays (FPGA) (not shown), one or more controllers (not shown), or one or more other special-purpose computer chips.

The processor 503 and accompanying components have connectivity to the memory 505 via the bus 501. The memory 505 includes both dynamic memory (e.g., RAM, magnetic disk, writable optical disk, etc.) and static memory (e.g., ROM, CD-ROM, etc.) for storing executable instructions that when executed perform the inventive steps described herein to controlling a set-top box based on device events. The memory 505 also stores the data associated with or generated by the execution of the inventive steps.

While certain exemplary embodiments and implementations have been described herein, other embodiments and modifications will be apparent from this description. Accordingly, the invention is not limited to such embodiments, but rather to the broader scope of the presented claims and various obvious modifications and equivalent arrangements.

What is claimed is:

1. A method comprising:
retrieving data associated with multiple accounts from multiple database records, wherein each database record of the multiple database records is associated with a different type of information;
creating a single database entry for each account of the multiple accounts based on the retrieved data;
compressing the single database entry; and
storing the compressed single database entry in a cache.

2. A method according to claim 1, wherein the each database record is a relational database.

3. A method according to claim 1, wherein the retrieving, the creating, the compressing, the storing, or a combination thereof are performed through an offline process.

4. A method according to claim 1, further comprising:
receiving a request to access information associated with one account of the multiple accounts; and
retrieving a compressed single database entry associated with the one account from the cache based on the request.

5. A method according to claim 4, wherein the retrieving is performed through a single fetch.

6. A method according to claim 4, further comprising:
decompressing the compressed single database entry from a binary format into an Extensible Markup Language (XML) format in response to the request.

7. A method according to claim 6, further comprising:
parsing the decompressed single database entry based on a type of information, a contextual criterion, or a combination thereof associated with the one account.

8. A method according to claim 7, further comprising:
identifying the requested information from the decompressed single database entry based on the parsed single database entry and the request.

9. An apparatus comprising:
a processor; and
a memory including computer program code for one or more programs,
the memory and the computer program code configured to, with the processor, cause the apparatus to perform the following,
retrieve data associated with multiple accounts from multiple database records, wherein each database record of the multiple database records is associated with a different type of information,
create a single database entry for each account of the multiple accounts based on the retrieved data,
compress the single database entry, and
store the compressed single database entry in a cache.

10. An apparatus according to claim 9, wherein the each database record is a relational database.

11. An apparatus according to claim 9, wherein the retrieving, the creating, the compressing, the storing, or a combination thereof are performed through an offline process.

12. An apparatus according to claim 9, wherein the processor is further configured to:
receive a request to access information associated with one account of the multiple accounts; and
retrieve a compressed single database entry associated with the one account from the cache based on the request.

13. An apparatus according to claim 12, wherein the retrieving is performed through a single fetch.

14. An apparatus according to claim 12, wherein the processor is further configured to:
decompress the compressed single database entry from a binary format into an Extensible Markup Language (XML) format in response to the request.

15. An apparatus according to claim 14, wherein the processor is further configured to:
parse the decompressed single database entry based on a type of information, a contextual criterion, or a combination thereof associated with the one account.

16. An apparatus according to claim 15, wherein the processor is further configured to:
identify the requested information from the decompressed single database entry based on the parsed single database entry and the request.

17. A system comprising an enhanced data retrieval platform configured to:
retrieve data associated with multiple accounts from multiple database records within multiple databases, wherein each database record of the multiple database records is associated with a different type of information;
create a single database entry for each account of the multiple accounts based on the retrieved data;
compress the single database entry; and
store the compressed single database entry in a cache.

18. A system according to claim 17, wherein the each database record is a relational database.

19. A system according to claim 17, wherein the retrieving, the creating, the compressing, the storing, or a combination thereof are performed through an offline process.

20. A system according to claim 17, wherein the enhanced data retrieval platform is further configured to:
receive a request to access information associated with one account of the multiple accounts from a user device; and
retrieve a compressed single database entry associated with the one account from the cache based on the request.

21. A system according to claim 20, wherein the retrieving is performed through a single fetch.

22. A system according to claim 20, wherein the enhanced data retrieval platform is further configured to:
decompress the compressed single database entry from a binary format into an Extensible Markup Language (XML) format in response to the request.

23. A system according to claim 22, wherein the enhanced data retrieval platform is further configured to:
parse the decompressed single database entry based on a type of information, a contextual criterion, or a combination thereof associated with the one account.

24. A system according to claim 23, wherein the enhanced data retrieval platform is further configured to:
identify the requested information from the decompressed single database entry based on the parsed single database entry and the request.
